(19) United States
(12) Patent Application Publication
(10) Pub. No.: US 2014/0352651 A1
(43) Pub. Date: Dec. 4, 2014

(54) HOUSING COVER, IN PARTICULAR PLASTICS OIL SUMP

(71) Applicant: IBS Filtran Kunststoff-/ Metallerzeugnisse GmbH, Morsbach (DE)

(72) Inventors: Jorge Jaspers, Morsbach (DE); Wolfgang Stausberg, Morsbach (DE)

(73) Assignee: IBS Filtran Kunststoff-/ Metallerzeugnisse GmbH, Morsbach (DE)

(21) Appl. No.: 14/282,517

(22) Filed: May 20, 2014

(30) Foreign Application Priority Data
May 28, 2013 (DE) 10 2013 008 982.4

(51) Int. Cl. F02B 77/00

(52) U.S. Cl. CPC F02B 77/00
USPC 123/195 C

(57) ABSTRACT

The invention relates to a housing cover made from plastic on an engine housing or gearbox housing made from metal in an internal combustion engine, said housing cover being secured by a plurality of fastening screws (5) against the housing, wherein the housing cover is secured against a bearing surface of the housing by an encircling fastening flange (3) made from plastic, and the fastening flange (3) is provided with penetration openings (4) through which the fastening screws (5) extend into threaded bores (13), which are coaxial with respect thereto, in the housing, wherein the fastening screws (5) are supported by a screw head (7) against the fastening flange (3) directly or with the interposition of a washer, the fastening flange (3) bears without a gap against the bearing surface of the housing, and the fastening screws (5) are secured within the threaded bore (13) against automatic unscrewing.

The invention relates to a housing cover made from plastic on an engine housing or gearbox housing made from metal in an internal combustion engine, said housing cover being secured by a plurality of fastening screws against the housing, wherein the housing cover is secured against a bearing surface of the housing by an encircling fastening flange made from plastic, and the fastening flange is provided with penetration openings through which the fastening screws extend into threaded bores, which are coaxial with respect thereto, in the housing.

A housing cover of the type mentioned at the beginning in the form of an oil sump for an internal combustion engine is known, for example, from WO 2009/115440 A1. Such oil sumps for engine oil or gearbox oil or else gearbox covers are secured on a gearbox housing, engine block or the like with the aid of fastening screws. The fastening screws are customarily guided through fastening eyes integrally formed on the housing cover and engage in threaded bores in the engine block or in the gearbox housing of the internal combustion engine. The engine block or the gearbox housing is customarily composed of aluminium. As is known, the tightness between, for example, an oil sump and an engine block is ensured by compressing a sealing element in the direction of the fastening force produced by the fastening screws.

In order to obtain sufficient sealing between the housing cover and the engine housing or gearbox housing, a certain surface pressure has to be exerted on the connection component or on the bearing surface on the engine housing or gearbox housing via the fastening flange of the housing cover. Furthermore, it should be ensured that the fastening screws are tightened with a minimum prestressing force in order to ensure the strength of the connection and in order to obtain a required minimum surface pressure between the housing cover and the connection component or between the fastening flange and the bearing surface of the housing.

It is known that, in particular, thermoplastics become plastic under pressure loading and flow. Introduction of increased supporting forces into the plastics component for the purpose of increasing the surface pressure is normally avoided, since the plastics component would relax, which would result in a loss of the screw-prestressing force. This would firstly cause the required surface pressure between the plastics component and the connection component, i.e. between the housing cover and the engine housing or gearbox housing, no longer to be able to be applied and, secondly, this would result in either the one or other fastening screw working loose. It is therefore customary to insert stabilization sleeves or supporting sleeves into penetration openings of plastics components which are screwed against metal components, said stabilization sleeves or supporting sleeves absorbing the connecting forces, and therefore the prestressing force of the fastening screw concerned is maintained. As a result, the connection between the housing cover and the engine housing or gearbox housing is always ensured.

However, it is possible that relaxation of the plastics components, for example the oil sump, may nevertheless result in leakages occurring, specifically because of the restoring forces arising because of the compression of a sealing element. This problem is described, for example, in WO 2009/115440 A1. To avoid this, it is proposed in WO 2009/115440 A1 that the connecting element in the form of a fastening screw is assigned to a connecting region and the sealing element is assigned to a sealing region, wherein the connecting region and the sealing region are formed independently of each other and are locally separated.

As already described in WO 2009/115440 A1, the relaxation of plastics covers or oil sumps made from plastic can be countered by an increased number of fastening screws because an approximately uniform surface pressure is thereby obtained. However, this is complicated insofar as the number of components used, both the number of fastening screws and the number of supporting sleeves, causes the component to be significantly more expensive. Furthermore, the component weight and the outlay on assembly increase. Finally, the number of fastening eyes to be provided on the housing cover also increases, and therefore the injection-moulding die required is likewise more complicated.

The invention is therefore based on the object of providing a housing cover made from plastic on an engine housing or gearbox housing made from metal in an internal combustion engine, said housing cover avoiding the previously mentioned disadvantages, and in particular being light, simple to fit and requiring the smallest possible number of components.

The object is achieved by a housing cover made from plastic on an engine housing or gearbox housing made from metal in an internal combustion engine, said housing cover being secured by a plurality of fastening screws against the housing, wherein the housing cover is secured against a bearing surface of the housing by an encircling fastening flange made from plastic, and the fastening flange is provided with penetration openings through which the fastening screws extend into threaded bores, which are coaxial with respect thereto, in the housing, wherein the fastening screws are supported against the fastening flange by a screw head directly or with the interposition of a washer, the fastening flange bears in a substantially gap-free manner against the support surface of the housing, and the fastening screw is secured within the threaded bore against automatic unscrewing.

The gap-free resting of the surfaces of the fastening flange, on the one hand, and the bearing surface of the housing, on the other hand, on one another in the region of the connecting gap is achieved in particular by the fact that, unlike in the prior art, no supporting sleeve is provided in the relevant penetration opening of the housing cover and that, instead, the screw head is supported directly on the housing cover, and therefore, in addition to a sealing element to be provided between the fastening flange and the bearing, sealing is also achieved in the region of the gap between the components.

Surprisingly, it has turned out that a certain relaxation of the plastics component can be accepted if the fastening screw concerned is secured within the threaded bore against automatically unscrewing.

Such a means of securing against unscrewing can be ensured, for example, by the fact that the fastening screws are secured by a screw-securing means within the threaded bore. For example, an adhesive can be provided as the screw-securing means, said adhesive either being introduced separately into the threaded bore during assembly or having already been applied to the fastening screw before the screw connection. Particularly preferably, use is made, for example, of fastening screws having a screw-securing means already applied captively thereto.

For this purpose, for example, the threaded stem of the fastening screws can be coated with a micro-encapsulated adhesive which, during the production of the screw connection, is activated by the forces occurring in the thread.

Alternatively, provision can be made for the fastening screws to be coated with clamping material. For this purpose, said fastening screws can be coated, for example, with a polyamide powder which increases the friction forces occurring within the thread in such a manner that the frictional moment required in order to release the fastening screw is significantly increased.

The advantages of the solution according to the invention are obvious. Since, according to the invention, supporting sleeves are no longer required, the weight of the supporting sleeves, the material of the supporting sleeves and the required outlay on assembly are dispensed with. The supporting sleeves are customarily pressed into the plastics component.

It is also known to embed the supporting sleeves into the component, for example by insert moulding, as early as during the production of the plastics component.

Such a variant is described, for example, in WO 03/102387 A1.

The assembly of the component is considerably simplified by contrast thereto, and, finally, it is particularly advantageous that the diameter of the penetration openings can naturally be significantly smaller, and therefore the width of an encircling fastening flange of the housing cover can turn out smaller, which, in turn, is associated with a significant material and weight saving.

Finally, the external dimensions of the housing cover also become smaller as a result, and therefore a saving on construction space on the internal combustion engine can thereby be achieved.

In the event of an additionally provided means of securing a screw against unscrewing, for example by the use of adhesive- or clamping-material-coated fastening screws, a material-induced relaxation of the housing cover made from plastic can surprisingly be accepted within certain limits.

The housing cover according to the invention is composed, for example, of a polyamide with a fibre filling, for example in the form of glass fibres, of 10 to 60 ma %.

In a preferred variant of the housing cover according to the invention, it is provided that the clear width of the penetration openings is between 10 to 40% larger than the nominal diameter of the fastening screws. When fastening screws with the nominal diameter M6 are used, the diameter of the penetration opening can be, for example, 7.5 mm, which corresponds to an excess size of approximately 25%. The fastening screws can be tightened, for example, with a tightening torque of 10 Nm, and therefore the screw-prestressing force corresponds approximately to 10 kN.

Although the fastening screws are preferably supported by a screw head directly against the housing cover and the use of washers is basically not desirable because of the resulting increase in the number of separating gaps, support of the fastening screws against the housing cover made from plastic with the interposition of a washer or the like is within the scope of the invention.

In a particularly expedient and preferred variant of the housing cover according to the invention, it is provided that the fastening screws are fixed captively to the housing cover, specifically in such a manner that compensation for the positional tolerances of the fastening screws is possible during assembly. Compensation for positional tolerances within the context of the present application should be understood as meaning that the relevant fastening means, for example the fastening screw, can be shifted transversely with respect to its longitudinal extent in such a manner that, for example, in the case of a metric thread with an outside diameter of 6 mm, alignment tolerances between the penetration opening in the housing cover and the threaded bore in the connection component of more than 1 mm can be compensated for.

In a furthermore preferred variant of the housing cover according to the invention, it is provided that said housing cover is designed as an engine oil sump or as a gearbox oil sump.

Furthermore, at least one sealing means, for example a sealing ring, a sealing cord or a sealing lip or the like made from an elastomeric plastic can be provided between the fastening flange and the bearing surface of the housing.

In an advantageous refinement of the housing cover according to the invention, the latter comprises at least one captive retaining means for at least one fastening screw, said captive retaining means comprising a clamping bushing which engages around a threaded stem of a fastening screw and is in engagement therewith in such a manner that the threaded stem is fixed non-positively in the threaded bushing, wherein the clamping bushing is inserted into the penetration opening and fixed axially therein and the clamping bushing can be shifted in the circumferential direction of the penetration opening.

Thus, in an advantageous manner, first of all the fastening screw is held captively within the penetration opening and, secondly, compensation for positional tolerances of the fastening screw concerned is possible by the fact that the clamping bushing can be shifted in the radial direction of the penetration opening.

The invention is explained below with reference to exemplary embodiments depicted in the drawings, in which

FIG. 1 shows a sectional view through an oil sump, which is fastened to a gearbox housing, in the connecting region,

FIG. 2 shows a top view of the fastening flange of the oil sump according to FIG. 1,

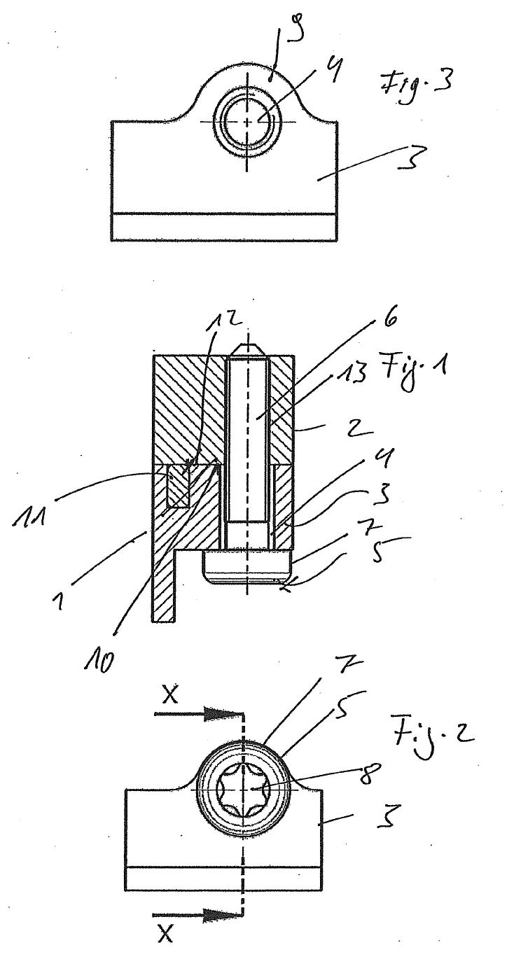

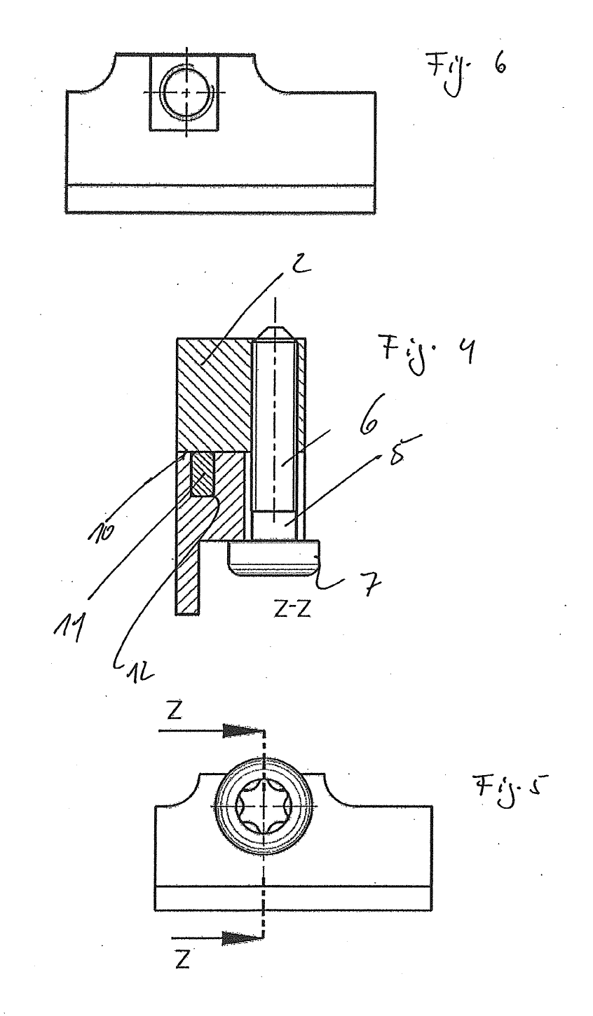

FIG. 3 shows a top view corresponding to FIG. 2 without the fastening screw,

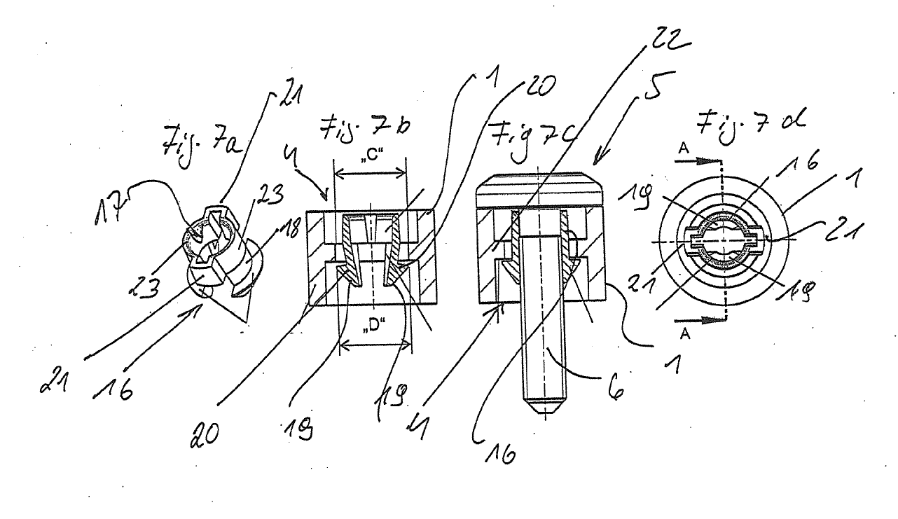

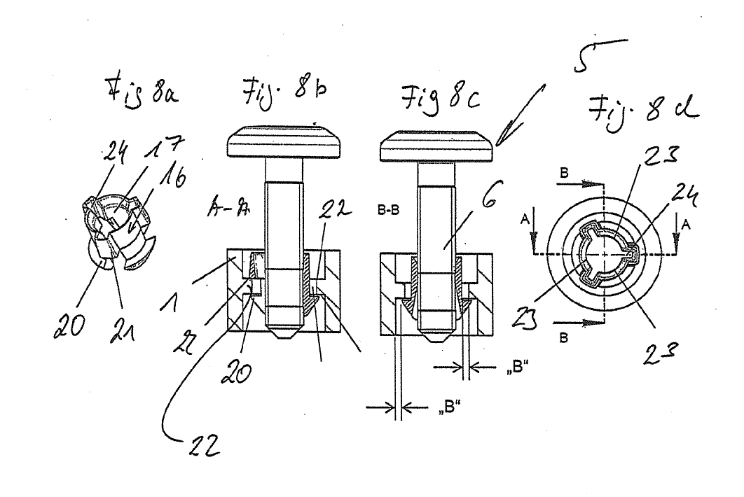

FIGS. 4 to 6: show a view, corresponding to FIGS. 1 to 3, of a second exemplary embodiment according to the invention,

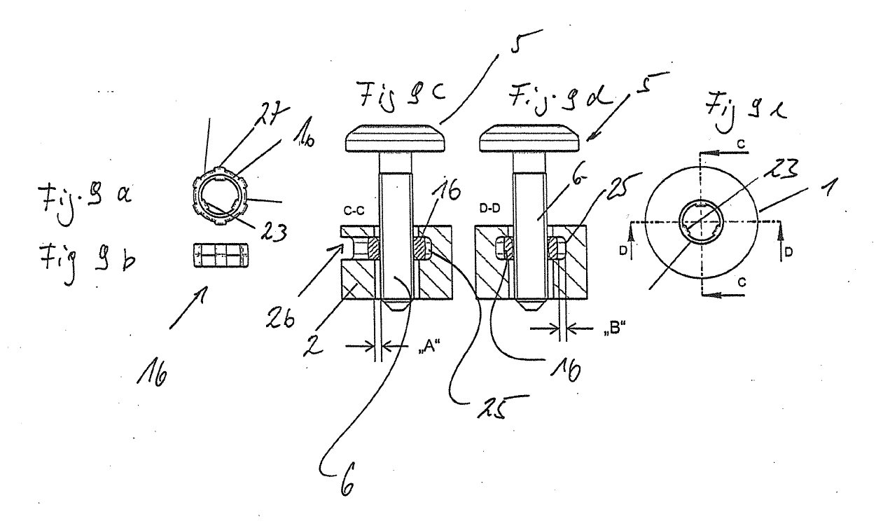

FIGS. 7a to 7d: show a first variant of a captive retaining means for the fastening screws on a housing cover according to the invention,

FIGS. 8a to 8d: show a second variant of the captive retaining means shown in FIGS. 7a to 7d,

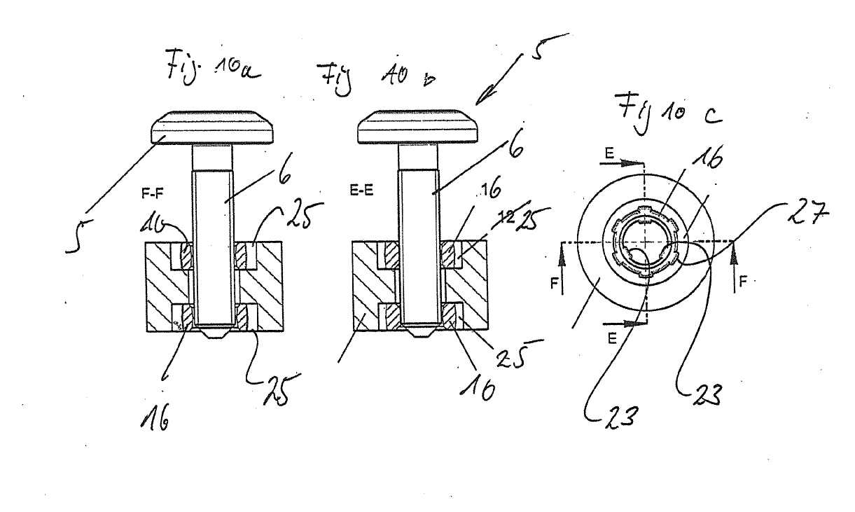

FIGS. 9a to 9e: show a further variant of a captive retaining means for a fastening screw on a housing cover according to the invention, and

FIGS. 10a to 10c: show a fourth variant of a captive retaining means for a fastening screw on a housing cover according to the invention.

In the drawings, the housing cover in the form of an oil sump 1 made from thermoplastic for a gearbox housing 2 on an internal combustion engine is not completely illustrated; rather, only a partial section in the region of a screw connection is illustrated.

The oil sump 1 is essentially in the form of a cover-shaped, trough-shaped structure with an encircling fastening flange 3 and a multiplicity of penetration openings 4, which pass through the fastening flange 3 at a distance from one another and are intended for fastening screws 5. The fastening screws 5 comprise a threaded stem 6 with a preferably metric thread and with a screw head 7 with a hexagon socket 8. In the exemplary embodiment of the housing cover according to the invention illustrated in FIGS. 1 to 3, the penetration openings 4, only one of which is illustrated, are in each case provided in fastening eyes 9 integrally formed on the fastening flange 3. The oil sump 1 is tightened in an encircling manner up against a corresponding bearing surface (countersurface) 10 of the gearbox housing 2 via the fastening screws 5. The gearbox housing 2 is composed of aluminium or of a comparable light metal, whereas the oil sump 1 is composed of a glass-fibre-filled polyamide, with the fibre filling being between 30 and 35 ma %.

To seal the oil sump 1 against the gearbox housing 2, the oil sump 1 comprises a sealing ring 11 which is made from an elastomeric material which is accommodated by an encircling groove 12 in the fastening flange 3.

As can be gathered in particular from FIGS. 1 and 4, the fastening screw 5 penetrates the penetration opening 4 and a threaded bore 13, which is aligned with respect thereto, in the gearbox housing, wherein the threaded stem 6 of the fastening screw 5 is in engagement with the thread of the threaded bore 13.

The sealing ring, which is denoted by 11, in uncompacted form has a larger volume than the volume of the groove 12 accommodating said sealing ring, and therefore, in the case of a fastening screw 5 tightened according to the specifications, the sealing ring 11 is compressed. The restoring force of the sealing ring 11 acts here counter to the screw-tightening force in the direction of the longitudinal axis of the fastening screw 5. If the fastening screw 5 has, for example, a threaded stem 6 with an M6 thread, said fastening screw can have been tightened, for example, with a screw-tightening torque of 10 Nm with a screw-prestressing force of approximately 10 kN.

The penetration opening 4 has an excess size of approximately 10 to 40%, preferably of 25%, in relation to the nominal diameter of the fastening screw 5.

The gap size of the separating gap 15 between the bearing surface 10 of the gearbox housing 2 and the sealing surface 14 of the fastening flange is ideally 0, to be precise without taking the microroughness of the surfaces resting on one another into consideration.

As is apparent from the drawings, the screw head 7 of the fastening screw 5 is supported directly on the fastening flange 3, i.e. without the use of an otherwise customary metal supporting sleeve.

By this means, it is basically possible to keep the diameter of the circular penetration opening 4 illustrated in FIGS. 1 to 3 relatively small, and therefore the width of the fastening flange 3 can likewise be selected to be relatively narrow.

As can be gathered in particular from FIGS. 4 to 6, it is not absolutely necessary to configure the penetration opening 4 as a circular bore; on the contrary, said penetration opening can also be in the form of a rectangular or cross-sectionally U-shaped break-through in the fastening flange 3.

The exemplary embodiment according to FIGS. 4 to 6 of the figures of the drawing differs in this respect from the exemplary embodiment illustrated in FIGS. 1 to 3.

Reference is now made to FIGS. 7 to 10 which show a captive retaining means for a fastening screw on the housing cover according to the invention.

If the fastening screws 5 can be premounted captively on the oil sump 1, assembly is made substantially easier. As already mentioned at the beginning, said fastening screws are preferably held on the gearbox housing 2 in such a manner that compensation for the positional tolerances of the fastening screws 5 is possible in each case. Compensation of positional tolerances should be understood as meaning compensation for possible alignment tolerances between the penetration openings 4 in the oil sump 1 and the threaded bores 13 in the gearbox housing 2.

Reference is made first of all to the exemplary embodiment according to FIGS. 7a to 7d. A section through a penetration opening 4 in the housing cover or oil sump 1 is illustrated in particular in FIGS. 7b and 7c. For simplification reasons, the gearbox housing 2 or the connection component is not illustrated.

A clamping bushing 16 is inserted into the penetration opening 4 which is, in the case of the exemplary embodiment according to FIGS. 7a to 7d, in the form of a circular bore. The clamping bushing 16 is latched in the circular penetration opening 4, wherein said clamping bushing is fixed axially by the latching, but nevertheless is mounted so as to be shiftable in the circumferential direction, i.e. in a floating manner, within the penetration opening 4.

The clamping bushing, for example in the form of a plastics component, is injection moulded from polyamide, polyethylene, ABS or the like. Said clamping bushing defines an approximately cylindrical receiving space 17 which forms two opposite clamping jaws 23. The guiding end of the clamping bushing 16 comprises two latching springs 18 which are arranged opposite each other and in each case form sliding ramps 19 which are bevelled in the direction of the guiding end of the clamping bushing 16 and in each case form latching hooks 20 which are of arrow-shaped design in cross section.

The guiding end of the clamping bushing 16 within the context of the present application means the end which forms the guiding end when the clamping bushing 16 is inserted into the penetration opening 4 concerned.

At that end of the clamping bushing 16 which is remote from the latching springs 18, said clamping bushing is provided with two insertion-limiting stops 21 which are arranged diametrically opposite each other and are offset by 90° with respect to the latching springs 18.

The clamping bushing 16 illustrated in FIG. 7a, as illustrated in FIG. 7b, is inserted with the guiding end thereof into the penetration opening 4 in such a manner that, in the fitted position of the clamping bushings 16, latching hooks 20 engage behind an encircling latching projection 22 in the penetration opening 4. In this position, the insertion-limiting stops 21 are supported on the encircling latching projection 22 such that the clamping bushing 16 is fixed axially.

The clear width C of the penetration opening 4 is somewhat smaller than the largest diameter D of the clamping bushing 16 at the largest circumference of the latching hooks 20. In the region of the latching springs 18 below the clamping jaws 23 of the clamping bushing 16, the clamping bushing 16 has an outside diameter which is smaller than the clear width C, and therefore the clamping bushing 16 is shiftable in the radial direction, i.e. is inserted into the penetration opening in a floating manner.

In the region of the clamping jaws 23, the receiving space 17 has a clear width which is slightly smaller than the nominal diameter of the fastening screw 5, and therefore the fastening screw 5 can be inserted into the receiving space 17 of the clamping bushing 16 with a press fit being formed. The fastening screw 5 is held in the clamping bushing 16 in such a manner that said fastening screw is movable axially into the clamping bushing 16 only counter to resistance. The clamping bushing 16 is, in turn, fixed axially within the penetration opening 4 and is shiftable therein in the circumferential direction, i.e. transversely with respect to the longitudinal extent of the fastening screw 5, wherein the size of the shift corresponds to the maximum compensation for positional tolerances for the fastening screw 5.

All of the fastening screws 5 on an oil sump 1 can thereby be fixed captively within the penetration openings 4 concerned. A possible alignment error or alignment tolerance between the penetration openings 4 in the oil sump 1 and the threaded bores 13 in the gearbox housing 2 can be compensated for by the radial play of the clamping bushings 16 in the penetration openings 4 concerned.

Instead of a single encircling latching projection 22 within the penetration opening 4, it is possible, for example, for a plurality of latching projections distributed discretely over the circumference of the duct opening to be provided.

An alternative configuration of the captive retaining means is illustrated in FIGS. 8a to 8d, wherein there, as in the exemplary embodiments below, functionally identical components are provided with the same reference numbers.

The exemplary embodiment described in FIGS. 8a to 8d differs from the exemplary embodiment described in FIGS. 7a to 7d in so far as the clamping bushing 16 comprise three latching springs 18 which each have three latching hooks 20, wherein the latching springs 18 and latching hooks 20 are arranged on the clamping bushing 16 over an angular extent of 120°.

Accordingly, a total of three insertion-limiting stops 21 are provided, which insertion-limiting stops are likewise in each case distributed on the outer circumference of the clamping bushing 16 over an angular extent of 120°.

In the two exemplary embodiments, the side walls 24 of the insertion-limiting stops 21 are of flexible design, and therefore, when the threaded stem 6 of the fastening screw 5 is pressed into the receiving space 17, the clamping jaws 23 can execute a yielding movement. For this purpose, it can be provided, for example, that the side walls 24 of the insertion-limiting stops 21 have film-hinge-like thin points in the region of the deflection thereof.

FIGS. 9a to 9c show a further exemplary embodiment of a captive retaining means for a housing cover according to the invention. In this example too, the housing cover or the oil sump 1 is illustrated only in the region of the penetration opening 4. The penetration opening 4 comprises a receiving pocket 25 which forms a partially encircling undercut of the penetration opening 4, wherein the receiving pocket 25 forms a lateral window 26 into which a clamping bushing 16 is inserted laterally. The width of the window 26 corresponds approximately to the outside diameter of the clamping bushing 16. Furthermore, the outside diameter of the clamping bushing 16 is of a larger size than the clear width of the penetration opening 4. The clamping bushing 16 is held within the receiving pocket 25 by the fastening screw 5 inserted through the receiving space 17 of said clamping bushing. As can be gathered in particular from FIGS. 9c and 9d, the threaded stem 6 of the fastening screw 5 passes through the receiving space 17 of the clamping bushing 16 arranged in the receiving pocket 25, wherein the threaded stem 6 is held within the receiving space 17 by three clamping jaws 23 arranged over an angular extent of 120°. The clamping jaws 23 are designed as cam-shaped projections in the receiving space 17 and engage around the fastening screw 5 in the manner of a press fit.

Furthermore, cams 27, the extent and number of which determine the rigidity of the clamping bushing 16 are provided on the outer circumference of the clamping bushing 16. The desired clamping force applied to the threaded stem 6 of the fastening screw 5 can be set via the extent and number of cams 27.

A fourth exemplary embodiment of the captive retaining means on the housing cover according to the invention is illustrated in FIGS. 10a to 10c. The penetration opening 4 in the oil sump is lowered on both sides such that said penetration opening has on both sides, i.e. both on the side facing the screw head 7 and on the side facing the connection component, a diameter which is larger than the outside diameter of the clamping bushing 16, and therefore a receiving pocket 25 for the clamping bushing 16 is formed in each case at both ends of the penetration opening 4. Furthermore, the cross section of the duct opening 4 is constricted, to be precise to a size which is approximately 25% larger than the nominal diameter of the fastening screw 5. The clamping bushing 16 according to the exemplary embodiment illustrated in FIGS. 10a to 10c otherwise corresponds to the clamping bushing 16 according to the exemplary embodiment illustrated in FIGS. 9a to 9e. By means of the mutually opposite arrangement of two clamping bushings 16 at a distance from each other, axial securing of the fastening screw 5 both in the tightening direction and in the release direction is achieved. Owing to the fact that the diameter of the receiving pocket 25 is significantly larger than the outside diameter of the clamping bushings 16, the clamping bushings 16 can shift in the circumferential direction, and therefore compensation for positional tolerances of the actuating screw 5 is thereby ensured.

### LIST OF REFERENCE NUMBERS

1 Oil sump

2 Gearbox housing

3 Fastening flange

4 Penetration openings

5 Fastening screws

6 Threaded stem

7 Screw head

8 Hexagon socket

9 Fastening eye

10 Bearing surface

11 Sealing ring

12 Groove

13 Threaded bore

14 Sealing surface of the fastening flange

15 Separating gap

16 Clamping bushing

17 Receiving space

18 Latching springs

19 Sliding ramps

20 Latching hook

21 Insertion-limiting stop

22 Latching projection

23 Clamping jaws

24 Side walls

25 Receiving pocket

26 Window

27 Cam

1. Housing cover made from plastic on an engine housing or gearbox housing made from metal in an internal combustion engine, said housing cover being secured by a plurality of fastening screws against the housing, wherein the housing cover is secured against a bearing surface of the housing by an encircling fastening flange made from plastic, and the fastening flange is provided with penetration openings through which the fastening screws extend into threaded bores, which are coaxial with respect thereto, in the housing, characterized in that the fastening screws are supported by a screw head against the fastening flange directly or with the interposition of a washer, in that the fastening flange bears directly against the bearing surface of the housing, and in that the fastening screws are secured within the threaded bore against automatic unscrewing.

2. Housing cover according to claim 1, characterized in that no supporting sleeve made from metal is provided in the penetration openings.

3. Housing cover according to claim 1, characterized in that the fastening screws are secured by a screw-securing means within the threaded bore.

4. Housing cover according to claim 3, characterized in that an adhesive is provided as the screw-securing means.

5. Housing cover according to claim 1, characterized in that an adhesive coating of the fastening screws is provided as the screw-securing means.

6. Housing cover according to claim 1, characterized in that the clear width of the penetration openings is between 10 and 40% larger than the nominal diameter of the fastening screws.

7. Housing cover according to claim 1, characterized in that the fastening screws are fixed captively to the housing cover.

8. Housing cover according to claim 1 as an engine oil sump or as a gearbox oil sump.

9. Housing cover according to claim 1, characterized in that at least one sealing means is provided between the fastening flange and the bearing surface of the housing.

10. Housing cover according to claim 1, comprising at least one captive retaining means for at least one fastening screw, said captive retaining means comprising at least one clamping bushing which engages around a threaded stem of a fastening screw and is in engagement with said threaded stem in such a manner that the threaded stem is fixed non-positively in the clamping bushing, wherein the clamping bushing is inserted into the penetration opening and is fixed axially therein, and the clamping bushing can be shifted in the radial direction of the penetration opening.
